(19) United States
(12) Patent Application Publication
(10) Pub. No.: US 2020/0325646 A1
(43) Pub. Date: Oct. 15, 2020

(54) Protection Assembly for an Elongate Member Deployed Underwater

(71) Applicant: Trelleborg Offshore UK Limited, Skelmersdale Lancashire (GB)

(72) Inventors: Austin Harbison, Skelmersdale (GB); Marc Ian Reeves, Skelmersdale (GB)

(21) Appl. No.: 16/772,868

(22) PCT Filed: Dec. 11, 2018
(86) PCT No.: PCT/GB2018/053581

§ 371 Date: Jun. 15, 2020

(30) Foreign Application Priority Data
Dec. 15, 2017 (GB) 1721014.7

(51) Int. Cl. E02B 17/00; H02G 1/08; H02G 1/10; H02G 9/00; F16L 1/12; F16L 5/00

(52) U.S. Cl. CPC E02B 17/00; H02G 1/081; H02G 1/10; E02B 2017/0091; F16L 1/123; F16L 5/00; E02B 2017/0095; H02G 9/00

(57) ABSTRACT

An assembly (10) protects an elongate member (e.g., an electrical cable) extending through an opening in a support structure (e.g., a wind turbine leg (12) and passes through at least one bend protector, e.g., a bend stiffener (20a, 20b), and a retaining device (18). The retaining device (18) has a body configured to lock itself to the opening. The body carries an abutment (78) and locking members (84), which are movable between retracted and extended positions. A movable member (86) is carried by the body (82), moveable axially with respect to it, and attachable to a pulling line. As the assembly (10) is pulled into the opening by the pulling line, the abutment (78) engages the support structure and arrests inward movement. The movable member (86) is moved in the inward direction with respect to the body (82), and the locking members (84) move to their extended positions to lock the retaining device in place.

The present invention relates to protection of an elongate flexible member passing through an opening in a structure underwater.

There are various practical situations in which a substantial but to some degree flexible elongate member such as a power cable, an umbilical, or a pipeline needs to be routed along the seabed to enter some support structure through an opening in it.

The invention is applicable in particular—but by no means exclusively—to protection of electric cables used in transmission of power from wind turbines. In an offshore wind farm, substantial electric cables typically run on the sea-bed from individual turbines to a collection station, which receives power from multiple turbines, and a further cable transmits power onward from the collection station to some shore-bound installation. Note that the term “offshore” is used herein to refer to an installation which is in water, but does not imply any particular distance of that installation from land, and should be understood to include installations in any body of water including a lake or river and not only the sea. Wind turbines often have a hollow leg structure mounted on a monopile driven into the sea bed (or lake bed etc.) and the cable can be led into the leg structure through an opening.

Certain technical challenges arise in this connection:
1. provision needs to be made for installation of the cable—that is, for drawing it into the turbine's supporting structure
2. the cable needs to be protected from damage during installation, in a potentially hostile environment. Turbines are for example often surrounded by rock dumps serving to protect the turbine's monopile foundations
3. the cable needs to be protected from subsequent damage during its design lifetime. In particular, it needs to be protected from damage by over-bending. Movement due for example to water flow over the cable could—if the cable were unprotected—lead to excessive local curvature, especially in the region where the cable emerges from the turbine's supporting structure.

It is known to protect elongate members deployed underwater from local physical damage and from over-bending by use of (a) bend stiffeners and (b) bend restrictors. A bend stiffener is a long sleeve to be placed around the elongate member, often of frusto-conical shape, which has a degree of flexibility but which is stiff enough to prevent the elongate member within from suffering an excessively tight radius of curvature. A bend restrictor is typically a set of components joined to each other in a linear chain through joints which permit a limited range of angular movement of one component relative to its neighbour. The components together form a continuous passage through which the elongate member is passed. Because of their limited range of angular movement they prevent excessively tight curvature.

The present invention may be employed in relation to bend stiffeners or to bend restrictors. The term “bend protector” is used in the claims to encompass devices of both types.

WO2010/038056 (Tekmar Energy Ltd.) describes a cable protection assembly having, in a linear sequential arrangement:
i. a first bend stiffener to be deployed inside a turbine's support leg;
ii. a “mechanical latch” formed as a cylinder with outwardly projecting spring-biased fingers. The mechanical latch is to be received in and to engage with an opening in the wall of the support leg through which the cable enters. Once it has been pulled into the opening, the mechanical latch's fingers spring outward to prevent it from being withdrawn;
iii. a second bend stiffener coupled to the latch; and
iv. a segmented bend restrictor coupled to the second bend stiffener.

Ropes are used to draw the assembly into the opening in the support leg until the mechanical latch is disposed in the opening and abuts the leg to prevent further inward movement. The spring biased fingers are pushed inwardly as they move through the opening and then spring outward once through it, so that they serve to retain the mechanical latch in the opening after release of the ropes.

WO2010/038056 suggests no means by which the sprung fingers of the mechanical latch could be withdrawn, to enable the cable protection assembly to be drawn out of the turbine leg should that prove necessary, and any such release appears difficult to achieve with the spring-biased finger arrangement.

GB2536075 (First Subsea Ltd.) discloses a different means of securing the protection assembly in the turbine leg, using a “mounting device” having an arrangement of captive balls which project radially outwardly though openings in a cylindrical sleeve. The balls run on respective ramps inclined to the axis of the mounting device, and the ramps are carried on a second sleeve within the first. In use, the mounting device is drawn into the opening in the turbine's leg and weight acting on the second sleeve urges moves it axially with respect to the first sleeve, causing the balls to be driven radially outwardly into engagement with the surrounding surface forming the opening.

It should be noted that the mounting device of GB2536075 works differently from the mechanical latch of WO2010/038056. In the device of '075, the balls engage frictionally with the periphery of the opening in the turbine leg, pushing radially outwardly against it. In the device of '056, the fingers engage instead with the inner surface of the turbine leg, mechanically locking the latch against withdrawal.

Another example of a mounting device using a ball and ramp type mechanism is provided in GB2546204, Balltec Ltd.

In all these ball and ramp type mechanisms, it is the weight of the assembly including the bend stiffener outside the turbine leg that acts on the ramps to maintain the balls in their outer positions.

Certain shortcomings are associated with the ball and ramp type of mechanism. The extent of the radial movement of the balls is limited. Effectively, since the balls must be captive, their projection is less than half of their diameter. So the “mounting device” needs to closely fit the opening in the turbine leg. The device depicted in GB2536075 uses a large number of individual ball and ramp arrangements, which adds to its complexity and expense. The mechanism functions by generation of large contact forces, so that its design must be such as to sustain these forces over a protracted design lifetime, which can again be a factor affecting the device's cost.

The ball and ramp devices also have a significant depth in the radial direction. This can be a limiting factor in design terms. The cables led into a turbine can be of large diameter. The opening in the turbine is of a specified size. There can be situations where the radial depth of a ball and ramp device makes it impossible to accommodate a required cable.

A different approach to the challenge of protecting a cable where it enters a turbine leg is found in WO2011/141494 (Seaproof Solutions AS), in which a bend stiffener section is mounted through the opening in the leg before the cable is drawn into it, this bend stiffener section providing a bell mouth through which the cable is to be drawn to enter the leg. A further bend stiffener assembly is carried on the cable itself, extending from the sea bed, through the bend stiffener section into the turbine leg. It appears that this further bend stiffener assembly is to be suspended from a cable within the turbine leg, and that no mechanical arrangement is provided to lock it in place with respect to the opening in the leg. Whether or not this represents a successful solution to the overall technical challenges, the arrangement is of increased complexity due to its use of two bend stiffeners, and its installation also involves additional steps since the further bend stiffener assembly needs to be assembled to the cable before the cable is pulled into the leg (and presumably before the cable is deployed to the seabed).

The present invention is intended to provide an improved form of retaining device able to locate in an opening in a support structure in a manner which resists withdrawal from it, and to receive a through-going elongate member which is to be protected.

In accordance with the present invention there is an assembly for protecting an elongate member which extends through an opening in a support structure, the assembly comprising a retaining device and at least one bend protector mounted to the retaining device, the bend protector and the retaining device having respective through-going passages which are aligned to receive the elongate member, the retaining device being configured to lock itself in place in the opening in the support structure and comprising:

a body for receipt in the opening in the support structure, the body having an inner end and an outer end;

an abutment carried by the body;

a plurality of locking members carried by the body and movable with respect to it between retracted and extended positions, the locking members being located between the abutment and the inner end of the body; and

a movable member which is carried by the body, is movable axially with respect to it, and is attachable to a pulling line; and

an actuating mechanism configured to move the locking members from their retracted positions to their extended positions as the movable member is moved with respect to the body in the direction from the outer end toward the inner end,

so that as the assembly is pulled into the opening in the support structure by means of the pulling line, with the inner end of the retaining device leading the outer end, the abutment engages the support structure and arrests inward movement of the body, the movable member is moved in the inward direction with respect to the body, and the locking members are thereby moved to their extended positions to lock the retaining device in the support structure.

Specific embodiments of the present invention will now be described, by way of example only, with reference to the accompanying drawings, in which:—

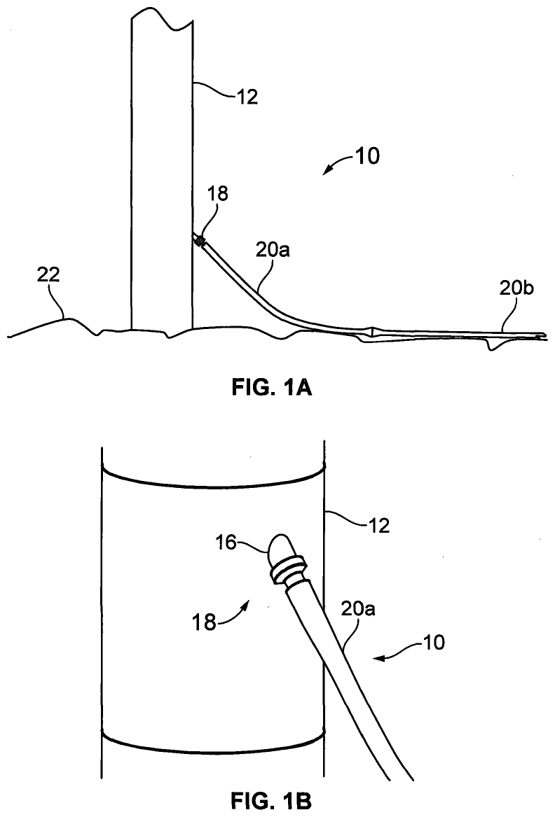

FIG. 1a shows a protection assembly for an elongate member embodying the present invention deployed under water upon a monopile leg of a wind turbine;

FIG. 1b is a further view of the protection assembly of FIG. 1, to a larger scale;

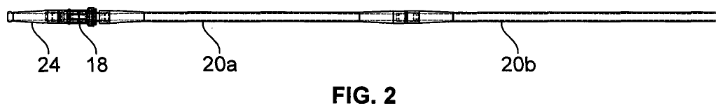

FIG. 2 shows the same protection assembly, without the monopile leg;

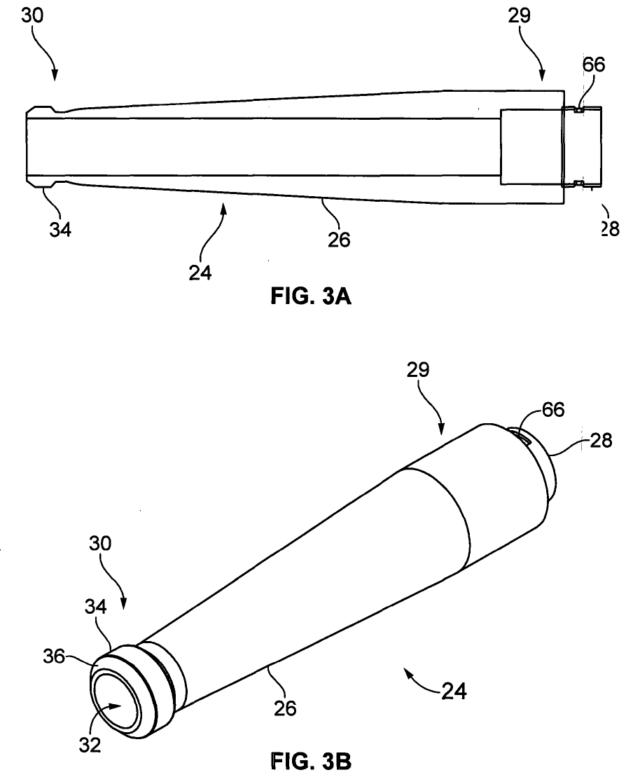

FIG. 3a is a section in an axial plane through an inner bend stiffener of the protection assembly;

FIG. 3b is a view of the exterior of the inner bend stiffener;

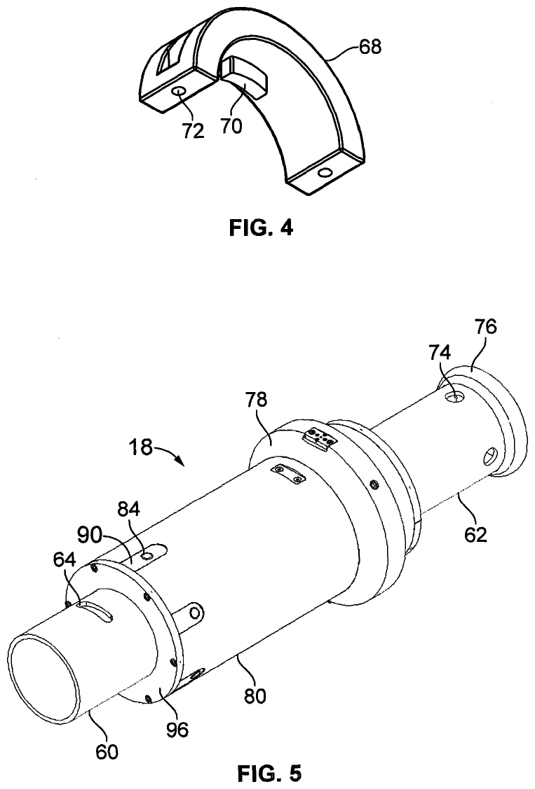

FIG. 4 shows a clamp shell used to secure the inner bend stiffener to a retaining device;

FIG. 5 shows the retaining device in an assembled state;

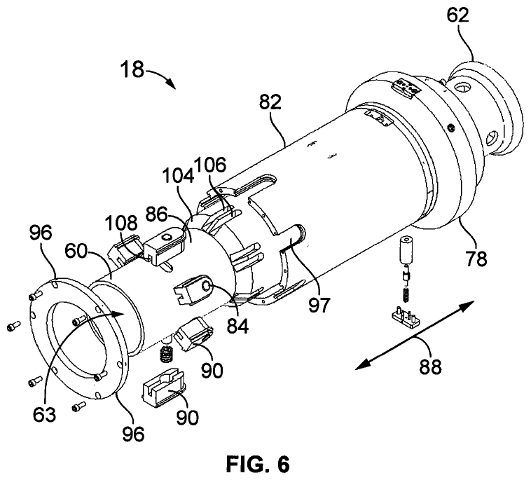

FIG. 6 shows the retaining device in a partly disassembled state;

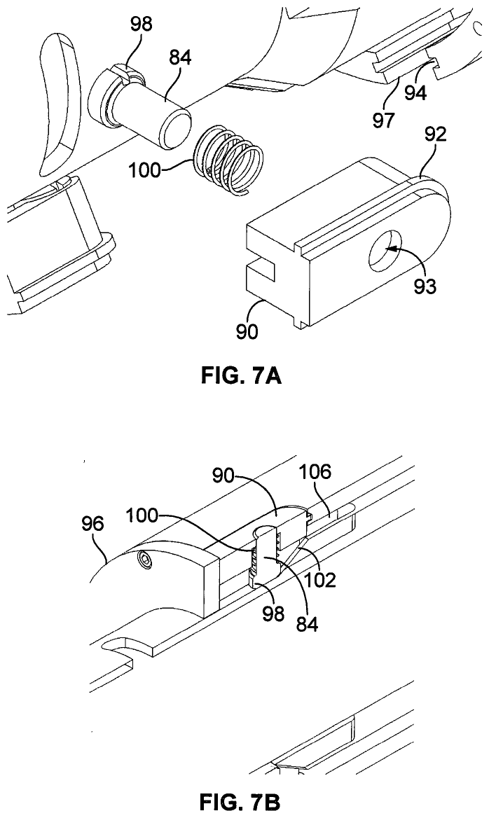

FIG. 7a is a scrap exploded view of parts of the retaining device;

FIG. 7b is an assembled, cut-away view of the same parts of the retaining device;

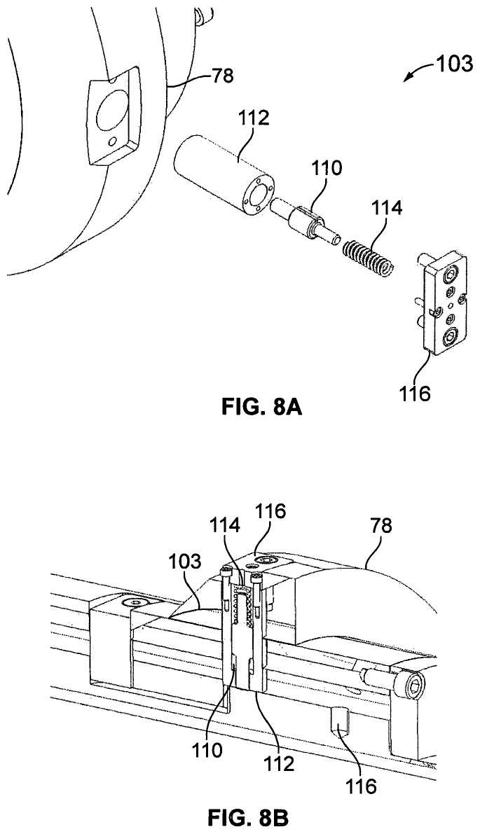

FIG. 8a is a scrap exploded view of a locking arrangement of the retaining device;

FIG. 8b is a sectional view of the same locking arrangement;

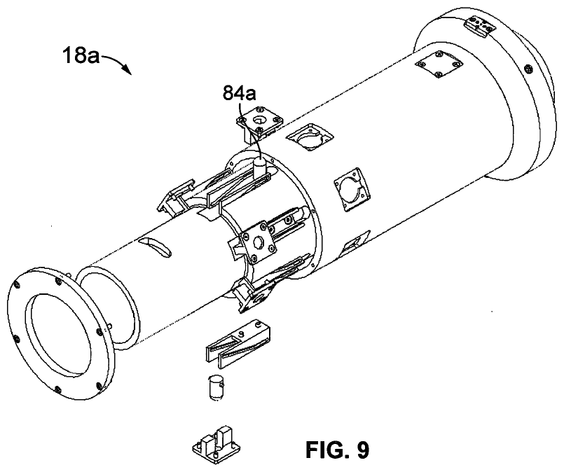

FIG. 9 shows a second retaining device embodying the present invention and suitable for use in the protection assembly of FIGS. 1 and 2 in a partly disassembled state;

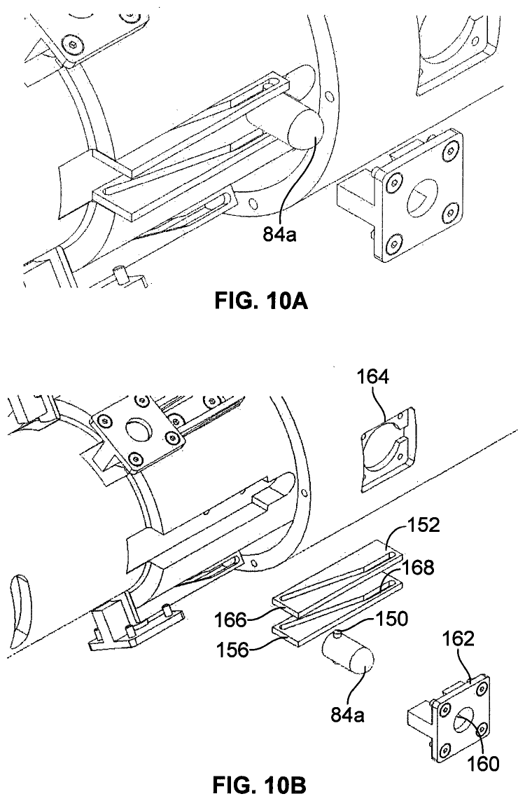

FIG. 10a shows an actuating mechanism of the second retaining device, the device being shown partly disassembled to reveal interior detail;

FIG. 10b is an exploded view of the same actuating mechanism;

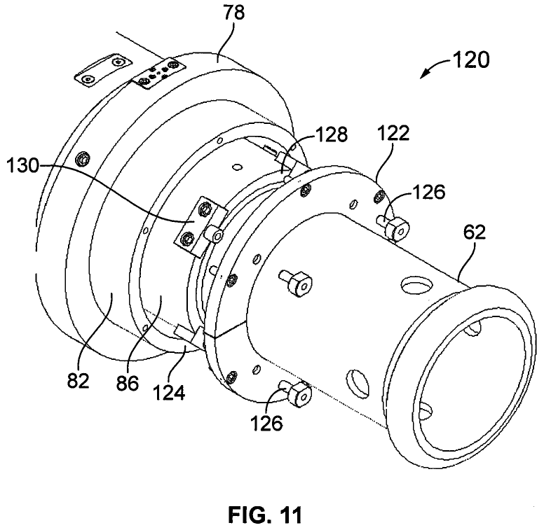

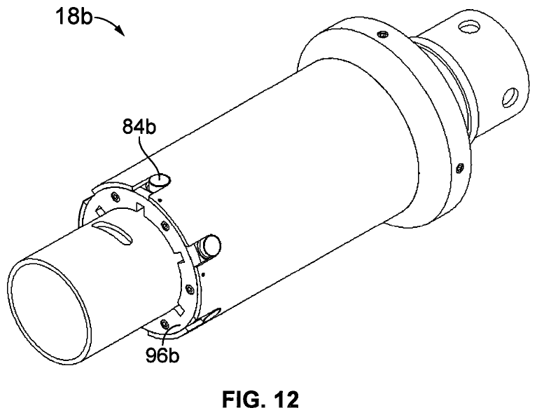

FIG. 11 depicts a restraint mechanism for preventing axial movement of a mandrel prior to deployment;

FIG. 12 shows a third retaining device embodying the present invention and suitable for use in the protection assembly of FIGS. 1 and 2; and

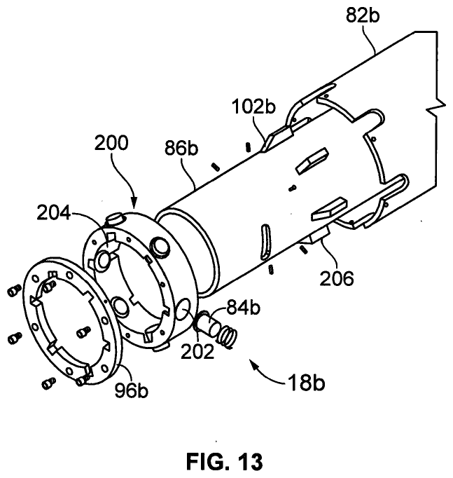

FIG. 13 shows the third retaining device exploded to reveal interior detail.

The embodiments to be described herein comprise a protection assembly 10 to be used where some form of elongate member capable of flexure enters a support structure. It is especially suited to use underwater in connection with an elongate member deployed on the seabed (and since the invention can be used in bodies of water other than the sea, including fresh water rivers or lakes, for example, the term “seabed” must be understood to be used here—for the sake of brevity—in a sense which encompasses the floor of any such body of water including a lake bed or river bed). The protection assembly 10 serves to provide the elongate member with protection against physical damage in the region where it enters the support structure. This includes protection against damage by over-bending, but also against abrasion and against impacts. Note that it may for example be necessary on occasion to dump rocks on the sea bed after cable installation, e.g. in response to scouring of the sea bed. Such dumps could damage an unprotected cable. There are other sources of potential impact damage such as ships' anchors.

The protection assembly 10 also serves to facilitate the process of drawing the elongate member into the support structure during its installation.

FIG. 2 depicts the entire protection assembly 10 and FIG. 1 shows it deployed upon a support structure in the form of a leg 12 of a wind turbine. As is well known, modern offshore wind turbines typically have a single upright tubular leg 12 mounted e.g. through a monopile driven into the seabed. In the installation depicted in FIGS. 1 and 2 an electrical cable, which is not seen in the drawings but is within the protection assembly 10, passes into the turbine leg 12 through an opening in the leg's tubular wall. The opening faces in a downwardly inclined direction. The protection assembly 10 comprises a retaining device 18 which is received in the opening 16 and which—by engagement with its periphery, in a manner to be explained below—serves to retain the whole protection assembly 10 in place. Coupled to the retaining device 18 is an external bend stiffener arrangement which in this embodiment comprises first and second external bend stiffeners 20a, 20b, one coupled to the other. Due to the downward inclination of the opening 16, and its own stiffness, the bend stiffener leads in a natural curve down to the sea bed 22 without excessive curvature of the cable within.

Looking at FIG. 2, the protection assembly 10 comprises, in a linear arrangement and in the following sequence:

an internal bend stiffener 24 which is disposed within the leg 12 in use;

the retaining device 18;

the first external bend stiffener 20a; and

the second external bend stiffener 20b.

These parts together form a continuous through-going passage for receiving and protecting the cable.

The internal bend stiffener 24 is best seen in FIGS. 3a and 3b. This part is referred to as “internal” merely because it is disposed within the leg 12 of the turbine once installed. It serves to prevent excessive curvature of the cable where it emerges from the retaining device 18 into the leg. In the present embodiment the internal bend stiffener 24 comprises an internal stiffener body 26 and an internal stiffener coupling 28. The internal stiffener body 26 is a unitary polymer moulded item in the present embodiment with a generally frusto-conical shape tapering inwardly from a root end 29 to a free end 30. It has enough flexibility to bend somewhat along with the cable, particularly toward its narrower free end 30, to avoid excessive local curvature of the cable where it emerges from the free end, but is also sufficiently rigid to prevent excessively tight curvature of the cable, which is protected within a through-going passage 32 of circular sectional shape. The material of the internal stiffener body 26 is a resilient polymer, specifically polyurethane. At or toward the free end 30, the internal stiffener body has a shaped engagement feature to engage with a releasable pulling clamp used to draw the protection assembly 10 into the leg during its deployment. In the present embodiment this engagement feature takes the form of an integrally formed collar 34.

The retaining device 18 comprises a mechanism which engages with the turbine leg 12 to secure the device in position in the leg. This mechanism can act automatically, so that once the retaining device 18 has been drawn into the opening in the leg it automatically makes the necessary engagement and secures the protection assembly 10 in place. The construction and operation of the retaining device 18 will now be described.

FIG. 5 shows the exterior of the retaining device 18, which has at one end an inner coupling 60 for coupling to the internal bend stiffener 24 and at its other end an outer coupling 62 for coupling to the first external bend stiffener 20a. The inner coupling 60 is tubular and is provided with coupling slots 64. It is insertable into the stiffener coupling 28 of the internal bend stiffener 24 to bring the coupling slots 64 into alignment with complementary coupling slots 66 of the stiffener coupling 28. A collar is used to lock these components together. One half 68 of the collar is depicted in FIG. 4, comprising a semi-annular body with a radially inwardly projecting dog 70 to pass through the coupling slots 64, 66. The depicted collar half is to be bolted to a second, identically formed, item through bolt holes 72 to surround the couplings 28, 60 and maintain them in engagement. In this way the inner bend stiffener 24 is mounted to the retaining device 18.

The outer coupling 62 is embedded in the polymer material forming the first external bend stiffener 20a to couple these parts together, although the external bend stiffener is omitted from FIG. 5. This can be achieved by placing the outer coupling 62 in the mould when the external bend stiffener is moulded. The outer coupling 62 has features of shape to provide firm engagement with the bend stiffener, these comprising through-going holes 74 and a flared portion 76 in the present embodiment.

Looking now at FIG. 6, it should be understood that the outer coupling 62 and the inner coupling 60 are at opposite ends of a mandrel 86 which passes right the way through a hollow cylindrical body 82. The inner coupling 60, the outer coupling 62 and the mandrel 86 form a single rigid component or assembly. This assembly is able to move somewhat with respect to the body 82 along the axial direction represented by arrow 88. The body 82 carries an abutment in the form of a stop collar 78, whose function will be explained below.

The mandrel is tubular, providing a through-going passage 63 which receives the cable being protected.

The body 82 carries guides 90 which receive and guide respective locking members 84. In the present embodiment the guides 90 each comprise a shaped block with a through-going bore 93 to receive one of the locking members 84 and a peripheral upstand 92 which engages in a complementarily formed channel 94 of a cut-away 97 formed in the body 82. These details are best seen in FIG. 7. A retainer ring 96 bolted to the body 82 locks the guides 90 in position with respect to the body 82. This form of construction is convenient. It enables pre-assembly of the guides 90 with their springs 100 and locking members 84, these assemblies then being introduced to the cut-aways 97. Machining of the body 82 is minimised. However the manner in which the locking members 84 are accommodated in the body 82 may differ in other embodiments.

The locking members 84 are movable radially to engage with/disengage from the periphery of the opening in the turbine leg, in use. In the present embodiment each is formed as a cylindrical pin which is a sliding fit in its respective bore 93. A collar 98 (see FIG. 7) carried by the locking member 84 renders it captive in the guide 90 and a helical spring 100 is compressed between the collar 98 and the guide 90 to urge the locking member 84 radially inwardly to cause it to be retracted into the device as depicted in FIG. 5, where only tips of the locking members 84 are visible. Other embodiments may use some other form of biasing arrangement acting on the locking members 84. Elastomer spring elements may be employed, for example. Alternatively the springs 100 may be dispensed with, as in the second embodiment to be described below.

An actuating mechanism comprising a ramp arrangement acts on each locking member 84, so that axial movement of the mandrel 86 with respect to the body 82 causes radially outward movement of the locking members 84. Refer in this connection to FIGS. 6 and 7b in particular. Ramp surfaces 102 are in the present embodiment formed on the mandrel 86 and act upon radially inner ends of the locking members 84. In the present embodiment the ramp surfaces 102 are formed by a frusto-conical portion 104 of the mandrel 86 (see FIG. 6). This frusto-conical portion is cut away to form channels 106 to either side of an upstand forming the ramp surface 102, and each guide 90 has a radially inwardly facing guide channel 108 which receives and embraces this upstand. In this way rotation of the mandrel 86 with respect to the body 82 is prevented and engagement of each locking member 84 with its respective ramp surface 102 is maintained.

FIG. 8 shows a locking arrangement 103 for locking longitudinal movement of the mandrel 86 with respect to the body 82 when it reaches the end of its travel, comprising a spring-loaded radially movable locking pin 110 which is mounted to the body 82 (and specifically in this example to the locking collar 78 carried by the body 82) in a tubular insert 112 and urged radially inwardly by a spring 114 whose force is reacted by a cover plate 116 secured to the body 82. Any other suitable biasing means may be employed in place of the spring 114. As the mandrel 86 is withdrawn from the body 82, the locking pin 110 is brought into alignment with a complementary recess 116 carried on the mandrel 86, causing the pin 110 to advance into the recess 116 and so to lock the mandrel 86 with respect to the body 82.

Prior to deployment of the protection assembly 10, the mandrel 86 is prevented from moving axially with respect to the body 82 by means of a restraint arrangement 120 depicted in FIG. 11 comprising an annular collar 122, which in the illustrated example is formed in two parts and which is coupled both to the body 82 and the mandrel 86. The collar seats against an end face 124 of the body 82 and is secured to it by threaded fasteners. Tension pins 126 connect the collar 122 to end face 128 of the mandrel 86. In the illustrated embodiment the tension pins 126 coupled to inserts 130 secured to the mandrel itself. It will be apparent that while this arrangement is intact it prevents any axial movement of the mandrel 86. The position of the mandrel 86 in this condition is such that the locking members 84 are maintained in their retracted positions. But the tension pins 126 have a specified maximum axial load, above which they break to release the mandrel 86.

Various aspects of the process of deployment and mounting of a protection assembly of the present general type are described in the applicant's published case WO2017/093725, to which attention is directed in this respect. For purposes of US law (and that of any other country in which it is permitted), this document is hereby incorporated by reference.

Briefly, a typical deployment process involves securing a pulling line to the protection assembly 10. This may be achieved by use of a clamp carried on the pulling line which engages with the collar 34 of the internal bend stiffener 24. The pulling line leads through the opening 16 in the turbine leg 12, so that drawing in the line draws first the internal bend stiffener 24 and then the retaining device 18 into the opening 16, until the stop collar 78 abuts the exterior of the turbine leg 12, preventing further inward movement of the assembly. At this point the locking members 84 lie inside the wall of the turbine leg. Continued pulling causes the restraint arrangement 120 to release, because the tension pins 126 break. The mandrel 86 is then able to move axially with respect to the body 82 (it moves to the left, as viewed in FIG. 5), causing the locking members 84 to be driven radially outwardly by their respective ramp surfaces 102. The mandrel's further movement brings the locking pin 110 into alignment with its recess 116, and engagement of the pin in the recess locks the mandrel 86 against further movement with respect to the body 82. The locking members 84 are thus retained in a radially outwardly extended state. When the pulling line is subsequently released, movement of the protection assembly 10 outward of the turbine leg 12 is prevented by engagement of the locking members 84 with the leg's interior surface at the periphery of the hole in the leg.

For straightforward deployment, it may be arranged that the coupling between the pulling line and the protection assembly 10 is itself frangible but releases at a higher loading than the restraint arrangement 120. A pulling line clamp suitable for this purpose is disclosed in the applicant's earlier application WO2017/093725. During deployment, once the stop collar 78 abuts the exterior of the turbine leg, tension in the puling line increases progressively. As it does so, the restraint arrangement 120 releases to lock the protection assembly 10 in place. Only after that has happened does the load become large enough to cause release of the pulling line.

Once deployed in this manner, the retaining device 18 may remain locked in position throughout its working lifetime. However it may sometimes be necessary to release it. This can be achieved by insertion of a pull out clamp (not shown) which loads the mandrel 86 sufficiently in an axial direction to break the locking pins 110, allowing the mandrel to move outwardly to cause the locking pins 84 to be retracted.

FIGS. 9 and 10 represent aspects of a second embodiment of the retaining device 18a which differs from the first with regard to the ramp mechanism used to extend the locking members 84a. In this embodiment the locking members 84a each carry a pair of follower stubs 150 which are received in respective actuator slots 152 formed in actuator plates 156 disposed to either side of the locking member 84a. The locking members 84a are each radially movable mounted in a radial bore 160 of a respective guide plate 162 which is bolted to the exterior of the body 82a, being received in a recess 164.

The actuator slots 152 each have a ramp portion 166 inclined with respect to the axis of the retaining device 18 to provide the required radial movement of the locking members 84a and a portion 168 which is parallel to the axis, allowing the mandrel 86 to move somewhat after the locking members 84a have been extended, to engage the locking arrangement 103 (which is formed in the present embodiment in the same manner already described with reference to the first).

The use of slots to actuate the locking members 84a makes it unnecessary to spring bias them inwardly, since the slots prevent unwanted outward movement of the members.

FIGS. 12 and 13 relate to a third embodiment of the retaining device 18b in which the construction of the ramp mechanism that actuates the locking members 84b is somewhat simplified. An annular guide collar 200 has radial bores 202 at regular intervals about its circumference and each receives a respective locking member 84b. Retaining ring 96b is bolted to the body 82b to secure the guide collar 200 in the body 82b. Longitudinally running recesses 204 in the collar's inner face register with ramps 206 upstanding from the mandrel 86b to define the rotational position of the guide collar 200 and ensure that the locking members 84b engage the ramp surfaces 102b. The operation of this embodiment is similar to that of the first embodiment.

The aforegoing embodiments are presented by way of example and not of limitation. Numerous variants are possible without departing from the scope of the invention as determined by the appended claims. While the illustrated embodiments have locking members 84 arranged in a circle, each at the same axial position along the retaining device 18, other arrangements of the locking members are possible. For instance there may be two circular arrangements at respective different axial positions, or the positions of the locking members may be staggered along the length of the retaining device 18. This can provide redundancy—if a first locking member or group of locking members breaks then further members toward the outer end of the device are still available to retain it in position.

1. An assembly for protecting an elongate member which extends through an opening in a support structure, the assembly comprising a retaining device and at least one bend protector mounted to the retaining device, the bend protector and the retaining device having respective through-going passages which are aligned to receive the elongate member, the retaining device being configured to lock itself in place in the opening in the support structure and comprising:
a body for receipt in the opening in the support structure, the body having an inner end and an outer end;
an abutment carried by the body;
a plurality of locking members carried by the body and movable with respect to the body between retracted and extended positions, the locking members being located between the abutment and the inner end of the body; and
a movable member which is carried by the body, is movable axially with respect to the body, and is attachable to a pulling line; and
an actuating mechanism configured to move the locking members from their retracted positions to their extended positions as the movable member is moved with respect to the body in the direction from the outer end toward the inner end,
so that as the assembly is pulled into the opening in the support structure by means of the pulling line, with the inner end of the retaining device leading the outer end, the abutment engages the support structure and arrests inward movement of the body, the movable member is moved in the inward direction with respect to the body, and the locking members are thereby moved to their extended positions to lock the retaining device in the support structure.

2. The assembly as claimed in claim 1 further comprising a locking mechanism configured to lock the movable member with respect to the body when the locking members are in their extended positions, thereby to maintain the locking members in the extended positions.

3. The assembly as claimed in claim 2, wherein the locking mechanism comprises a spring loaded member in one of the movable member and the body engageable with a complementary locking feature of the other of the movable member and the body.

4. The assembly as claimed in claim 1, wherein the actuating mechanism comprises ramp surfaces which act on the locking members.

5. The assembly as claimed in claim 4, wherein the movable member is movable along an axial direction with respect to the body, the ramp surfaces face radially outwardly with respect to the body, and the ramp surfaces incline toward the axis in a direction from the outer end of the body toward inner end of the body.

6. The as claimed in claim 5, wherein the movable member is disposed within the body.

7. The assembly as claimed in claim 6, wherein the movable member comprises a mandrel having, at the inner end of the body, a coupling for mounting an inner bend stiffener.

8. The assembly as claimed in claim 1, wherein the locking members comprise pins received in bores.

9. The assembly as claimed in claim 4, wherein the locking members each comprise a follower received in a slot that provides the ramp surface, the slot being formed with inwardly and outwardly facing surfaces for engaging the follower, to constrain its position in both inward and outward directions.

10. The assembly as claimed in claim 1 further comprising a releasable restraint arrangement which restrains axial movement of the movable member prior to deployment of the assembly, maintaining the locking members in their retracted positions.

11. The assembly as claimed in claim 10, wherein the restraint arrangement is configured to release the movable member when loading applied through the pulling line exceeds a threshold, enabling the locking members to be moved to their extended positions.

12. The assembly as claimed in claim 11, wherein the restraint arrangement comprises at least one breakable member through which the movable member is coupled to the body.

13. A retaining device for use in an assembly for protecting an elongate member which extends through an opening in a support structure, the retaining device being configured to mount at least one bend protector such that through-going passages in the retaining device and the bend stiffener align to receive the elongate member, the retaining device being configured to lock itself in place in the opening in the support structure and comprising:
a body for receipt in the opening in the support structure, the body having an inner end and an outer end;
an abutment carried by the body;
a plurality of locking members carried by the body and movable with respect to it the body between retracted and extended positions, the locking members being located between the abutment and the inner end of the body;
a movable member which is carried by the body, is movable axially with respect to the body, and is attachable to a pulling line; and
an actuating mechanism configured to move the locking members from their retracted positions to their extended positions as the movable member is moved with respect to the body in the direction from the outer end toward the inner end,
so that as the assembly is pulled into the opening in the support structure by means of the pulling line, with the inner end of the retaining device leading the outer end, the abutment engages the support structure and arrests inward movement of the body, the movable member is moved in the inward direction with respect to the body, and the locking members are thereby moved to their extended positions to lock the retaining device in the support structure.

14. An assembly for protecting an elongate member which extends through an opening in a support structure, the assembly comprising a retaining device and at least one bend protector mounted to the retaining device, the bend protector and the retaining device having respective through-going passages which are aligned to receive the elongate member, the retaining device being configured to lock itself in place in the opening in the support structure and comprising:
a body for receipt in the opening in the support structure, the body having an inner end and an outer end;
an abutment carried by the body;
a plurality of locking members carried by the body and movable with respect to it the body between retracted and extended positions, the locking members being located between the abutment and the inner end of the body;
a movable member which is carried by the body, is movable axially with respect to the body, and is attachable to a pulling line; and
an actuating mechanism configured to move the locking members from their retracted positions to their extended positions as the movable member is moved with respect to the body,
wherein the locking members comprise elongate pins received in bores,
so that as the assembly is pulled into the opening in the support structure by means of the pulling line, with the inner end of the retaining device leading the outer end, the abutment engages the support structure and arrests inward movement of the body, the movable member is moved in the inward direction with respect to the body, and the locking members are thereby moved to their extended positions to lock the retaining device in the support structure.
